(19) United States
(12) Patent Application Publication
(10) Pub. No.: US 2025/0330527 A1
(43) Pub. Date: Oct. 23, 2025

(54) METHOD FOR PROVIDING SPATIAL INFORMATION MANAGEMENT AND DEVICES FOR PERFORMING THE SAME

(71) Applicant: Electronics and Telecommunications Research Institute, Daejeon (KR)

(72) Inventors: Byungjun AHN, Daejeon (KR); Soohwan LEE, Daejeon (KR)

(73) Assignee: Electronics and Telecommunications Research Institute, Daejeon (KR)

(21) Appl. No.: 19/170,278

(22) Filed: Apr. 4, 2025

(30) Foreign Application Priority Data
Apr. 5, 2024 (KR) 10-2024-0046972
May 13, 2024 (KR) 10-2024-0062663
Jul. 1, 2024 (KR) 10-2024-0086057
Aug. 9, 2024 (KR) 10-2024-0106976
Oct. 8, 2024 (KR) 10-2024-0136334
Apr. 2, 2025 (KR) 10-2025-0043013

(51) Int. Cl. H04L 67/52; H04L 67/131

(52) U.S. Cl. CPC H04L 67/52; H04L 67/131

(57) ABSTRACT

A method for providing spatial information management and devices for performing the same are disclosed. A method of managing information of a spatial map according to an embodiment includes receiving a request for a service operation for spatial map management, performing the service operation for the spatial map management, and transmitting a response including a result of performing the service operation for the spatial map management to an entity requesting the service operation for the spatial map management, wherein the service operation for the spatial map management may include a create spatial map service operation, a get spatial map service operation, an update spatial map service operation, a delete spatial map service operation, and a subscribe spatial map service operation, and the information of the spatial map may include a spatial map ID, spatial map coverage, access control rules, a list of spatial map layers, and objects of a spatial map.

### TECHNICAL FIELD

The following disclosure relates to a method for providing spatial information management and devices for performing the same.

### BACKGROUND OF THE INVENTION

The metaverse is an open, shared, and continuous virtual world that provides access to user-created three-dimensional (3D) virtual spaces, solutions, and environments. The metaverse is a digital reality that combines aspects of social media, online gaming, augmented reality (AR), virtual reality (VR), and cryptocurrencies, allowing users to interact virtually. As the metaverse grows, an online space where user interaction is more multidimensional than current technologies support may be created. Instead of viewing digital content, users in the metaverse may immerse themselves in a space where digital and physical worlds converge.

The above description has been possessed or acquired by the inventor(s) in the course of conceiving the present disclosure and is not necessarily an art publicly known before the present application is filed.

### DISCLOSURE OF INVENTION

### Technical Goals

Embodiments may provide a technique for managing a spatial map and/or spatial map information.

However, the technical aspects are not limited to the aforementioned aspects, and other technical aspects may be present.

### Technical Solutions

A method of managing information of a spatial map according to an embodiment includes receiving a request for a service operation for spatial map management, performing the service operation for the spatial map management, and transmitting a response including a result of performing the service operation for the spatial map management to an entity requesting the service operation for the spatial map management, wherein the service operation for the spatial map management may include a create spatial map service operation, a get spatial map service operation, an update spatial map service operation, a delete spatial map service operation, and a subscribe spatial map service operation, and wherein the information of the spatial map may include a spatial map ID, spatial map coverage, access control rules, a list of spatial map layers, and objects of a spatial map.

The access control rules may define an entity capable of discovering and accessing the spatial map.

The entity requesting the service operation for the spatial map management may be a spatial map client or a VAL server.

The method may further include transmitting a notification to an entity requesting a subscribe spatial map service operation among the service operation for the spatial map management in response to detecting an event for the spatial map.

When the event is a change of an object in the spatial map, the notification may include information about an addition, removal, change of location, or change of orientation of the object.

A device for managing information of a spatial map according to an embodiment includes at least one processor including processing circuitry and memory storing instructions that, when executed by the at least one processor individually or collectively, cause the electronic device to, receive a request for a service operation for spatial map management, perform the service operation for the spatial map management, and transmit a response including a result of performing the service operation for the spatial map management to an entity requesting the service operation for the spatial map management, wherein the service operation for the spatial map management may include a create spatial map service operation, a get spatial map service operation, an update spatial map service operation, a delete spatial map service operation, and a subscribe spatial map service operation, and wherein the information of the spatial map may include a spatial map ID, spatial map coverage, access control rules, a list of spatial map layers, and objects of a spatial map.

The access control rules may define an entity capable of discovering and accessing the spatial map.

The entity requesting the service operation for the spatial map management may be a spatial map client or a VAL server.

The instructions, when executed by the at least one processor individually or collectively, may cause the electronic device to, transmit a notification to an entity requesting a subscribe spatial map service operation among the service operation for the spatial map management in response to detecting an event for the spatial map.

When the event is a change of an object in the spatial map, the notification may include information about an addition, removal, change of location, or change of orientation of the object.

### BRIEF DESCRIPTION OF DRAWINGS

FIG. 1 is a diagram illustrating a network system according to an embodiment.

FIG. 2 is a diagram illustrating a spatial map service according to an embodiment.

FIG. 3 is a diagram illustrating a method of supporting spatial map management according to an embodiment.

FIG. 4 is a diagram illustrating an example of a spatial map management procedure according to an embodiment.

FIG. 5 is a diagram illustrating another example of a spatial map management procedure according to an embodiment.

FIG. 6 is a diagram illustrating another example of a spatial map management procedure according to an embodiment.

FIG. 7 is a diagram illustrating another example of a spatial map management procedure according to an embodiment.

FIG. 8 is a diagram illustrating another example of a spatial map management procedure according to an embodiment.

FIG. 9 is a diagram illustrating another example of a spatial map management procedure according to an embodiment.

FIG. 10 is a diagram illustrating another example of a spatial map management procedure according to an embodiment.

FIG. 11 is a diagram illustrating another example of a spatial map management procedure according to an embodiment.

FIG. 12 is a schematic block diagram of a device supporting spatial map management according to an embodiment.

### BEST MODE FOR CARRYING OUT THE INVENTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly, the second component may also be referred to as the first component.

It will be understood that when a component is referred to as being “connected to” or “coupled” to another component, the component may be directly connected or coupled to the other component or intervening components may be present.

As used herein, the singular forms “a,” “an,” and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like components, and any repeated description related thereto will be omitted.

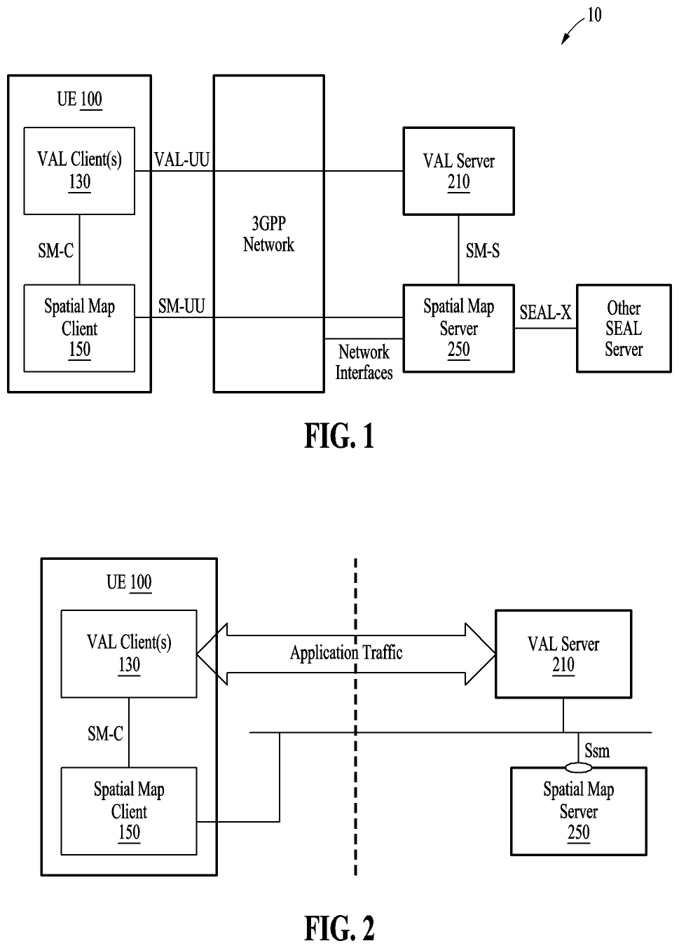

FIG. 1 is a diagram illustrating a network system according to an embodiment, and FIG. 2 is a diagram illustrating a spatial map service according to an embodiment.

Referring to FIGS. 1 and 2, a network system 10 (e.g., a fifth generation (5G) network system, a sixth generation (6G) network system, or a 5G/6G network system) according to an embodiment may be for spatial map management. Spatial map management may be a service enabler architecture layer (SEAL) service that provides spatial map related capabilities to vertical application(s). The network system 10 may include a plurality of entities 100 to 250 to support spatial maps for vertical application(s). A UE 100 may include a VAL client 130 and a spatial map client 150.

A spatial map management functional entity may be grouped into a vertical application layer and a SEAL. The spatial map management function may provide a vertical application layer with a function of spatial map management. A spatial map management functional model may be based on a SEAL layer (e.g., as specified in 3GPP TS 23.434). The spatial map functional entity on the UE 100 may be the spatial map client 150, and the spatial map functional entity in a network may be a spatial map server 250. The VAL client 130 may be an application client that provides application services to a user, and a VAL server 210 may be a server that provides application services to a user. The spatial map client 150 may provide client side functionalities for managing spatial maps for applications, and the spatial map server 250 may provide server side functionalities for managing spatial maps for applications. The spatial map client 150 may be a SEAL client that provides spatial map services to the VAL client 130. The spatial map server 250 may be a SEAL server that provides spatial map services to the VAL server 210 and the UE 100. An interface between the spatial map client 150 and the spatial map server 250 may be SM-UU. The spatial map client 150 may interact with the VAL client 130 using an SM-C interface. The spatial map server 250 may interact with the VAL server 210 using SM-S. The spatial map server 250 may communicate (e.g., directly or via NEF) with an underlying 3GPP network system using a 3GPP interface specified by a 3GPP network system (e.g., T8, N33). When the spatial map server 250 is deployed by a PLMN operator, the spatial map server 250 may communicate with the 3GPP network system by directly invoking APIs exposed by 3GPP core network functions. The spatial map server may interact with another SEAL server (e.g., a spatial anchors management server and/or a location management server) via a SEAL-X (AnM) reference point.

The spatial map server 250 may act as a SEAL server. For example, the spatial map server 250 may provide services to create/get/update/delete/discover/subscribe a spatial map for a VAL application (e.g., a metaverse application). Additionally, the spatial map server may provide a spatial localization service. The spatial map server 250 may communicate with another spatial map server in a distributed SEAL deployment.

The spatial map client 150 may act as a SEAL client for spatial map functionality. For example, the spatial map client 150 may support client side functionalities for creating/updating/deleting/discovering/retrieving/subscribing a spatial map for a VAL application (e.g., a metaverse application). Additionally, the spatial map client 150 may provide a spatial localization service. The spatial map client 150 may receive a request from the VAL client 130 to perform specific functionality.

The VAL server 210 (e.g., as specified in clause 6.4.2.3 of 3GPP TS 23.434) may provide server side functionalities corresponding to a vertical application (e.g., a metaverse application) to a client of a VAL user based on a service contract.

The VAL client 130 (e.g., as specified in clause 6.4.2.2 of 3GPP TS 23.434) may provide a metaverse service to a user. The VAL client 130 may manage a spatial map of an application by using the spatial map client 150.

An SM-UU reference point may enable interaction between the spatial map client 150 and the spatial map server 250. The SM-UU reference point may be used to create/update/delete/discover/get/subscribe to a spatial map for a VAL application (e.g., a metaverse application).

An SM-C reference point may enable interaction between the spatial map client 150 and the VAL client 130 (e.g., a metaverse application client). The SM-C reference point may be used by the VAL client 130 to share spatial map related information with the spatial map client 150 and to obtain (create/update/delete/get/subscribe) the spatial map related information from the spatial map client 150.

As illustrated in FIG. 2, the spatial map server 250 may expose APIs to the VAL server 210 and the spatial map client 150 via an Ssm interface. The VAL server 210 may consume the services by interacting on the Ssm interface of the spatial map server 250. CAPIF may be used by the VAL function to discover the services of the spatial map server 250.

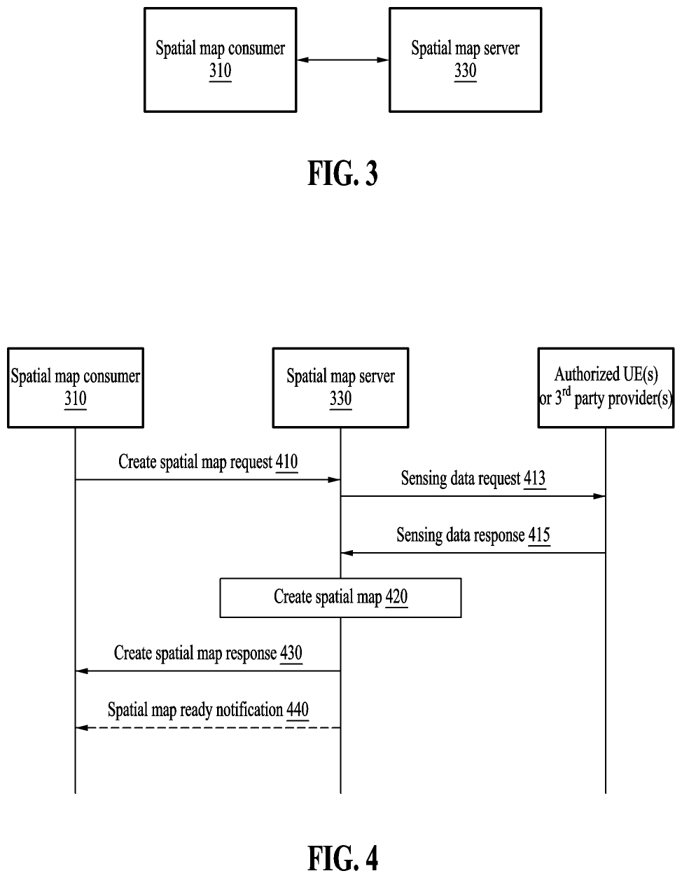

FIG. 3 is a diagram illustrating a method of supporting spatial map management according to an embodiment.

Referring to FIG. 3, a spatial map server 330 (e.g., the spatial map server 250 of FIGS. 1 and 2) may store and manage spatial map information for a spatial map. The spatial map may be a 3D map of an indoor or outdoor environment. The spatial map may be used to provide a spatial localization service to a customer (or consumer) and provide an association between service information and locations in 3D space, and the spatial map may allow a customer to identify and access a metaverse service (e.g., information to access AR media content). The spatial map may be a collection of information corresponding to a given 3D space. The collection of information may include information collected from sensors, and the information may be related to characteristics of an object in the space. For example, the information may include appearance information such as the number of objects, the type and position of an object, and the direction and velocity of a moving object. Table 1 may illustrate an example of information elements included in the spatial map information.

TABLE 1

| Information | | |
|---|---|---|
| element | Status | Description |
| Spatial map ID | M | The identifier of the spatial map |
| Spatial map | M | The 3D space coordinates information of the |
| coverage | | spatial map |
| Access control | O | Access control rules defining which entities are |
| rules | | permitted to discover and access the spatial map |
| List of spatial | M | The list of spatial map layer information. At least |
| map layers | | one or more spatial map layers should be |
| | | included. Each element includes the information |
| | | described below. |
| > Spatial map | M | The identifier of the corresponding spatial map |
| layer ID | | layer. |
| > Spatial map | O | A container to carry the corresponding spatial |
| layer | | map layer specific information |
| information | | |
| >> Area | O | The area covered by this layer. This area may be |
| | | the same or a subset of the spatial map coverage |
| | | space. |
| >> Associated | O | The details about a spatial map associated with |
| spatial map | | this layer. For example, when the layer is for a |
| | | particular floor of the building, the detailed spatial |
| | | map of that particular floor may be associated |
| | | with this layer. |
| > List of | O | List of object information. Each element includes |
| objects | | the information below. |
| >> Object ID | M | The identifier of the corresponding object |
| >> Object type | M | The type of object |
| >> Object | O | The 3D position of the object in the layer |
| position | | |
| >> Object | O | Object specific attribute information |
| specific | | |
| information | | |

A service (e.g., SS_SmManagement) for spatial map management may allow a spatial map consumer 310 to manage a spatial map in the spatial map server 330. The service for spatial map management may include services such as create spatial map (e.g., SS_SmManagement_Create), get spatial map (e.g., SS_SmManagement_Get), update spatial map (e.g., SS_SmManagement_Update), delete spatial map (e.g., SS_SmManagement_Delete), subscribe spatial map (e.g., SS_SmManagement_Subscribe), notify spatial map (e.g., SS_SmManagement_Notify), and unsubscribe spatial map (e.g., SS_SmManagement_Unsubscribe). The service (e.g., SS_SmManagement) for spatial map management may be as shown in Table 2.

TABLE 2

| | API | | Communication |
|---|---|---|---|
| API Name | Operations | Known Consumer(s) | Type |
| SS_ | Create | VAL server, SEAL SM | Request/ |
| SmManagement | | client | Response |
| | Get | VAL server, SEAL SM | |
| | | client | |
| | Update | VAL server, SEAL SM | |
| | | client | |
| | Delete | VAL server, SEAL SM | |
| | | client | |
| | Subscribe | VAL server, SEAL SM | Subscribe/ |
| | | client | Notify |
| | Notify | VAL server, SEAL SM | |
| | | client | |
| | Unsubscribe | VAL server, SEAL SM | |
| | | client | |

A create spatial map service operation (e.g., SS_SmManagement_Create) may be for creating a spatial map for a given 3D area of interest. A get spatial map service operation (e.g., SS_SmManagement_Get) may be for providing requested spatial map information to an authorized consumer. An update spatial map service operation (e.g., SS_SmManagement_Update) may be for updating information in a spatial map upon request. A delete spatial map service operation (e.g., SS_SmManagement_Delete) may be for deleting a spatial map. A subscribe spatial map service operation (e.g., SS_SmManagement_Subscribe) may be for handling subscriptions by authorized consumers to a spatial map event. A spatial map notification service operation (e.g., SS_SmManagement_Notify) may be for notifying an authorized consumer about a detected trigger event to which the authorized consumer has subscribed. An unsubscribe spatial map service operation (e.g. SS_SmManagement_Unsubscribe) may be for unsubscribing an authorized consumer from a spatial map event.

A spatial map consumer 310 may transmit a request for a service operation (e.g., a service operation described in Table 2) for spatial map management to the spatial map server 330. The spatial map consumer 310 may be a requester requesting a service operation for spatial map management, and may be the spatial map client 150 of the UE 100 or the VAL server 210.

The spatial map server 330 may perform a service operation for spatial map management in response to a request for a service operation for spatial map management. The spatial map server 330 may be a SEAL spatial map server. The spatial map server 330 may transmit a response to a request to the spatial map consumer 310.

FIG. 4 is a diagram illustrating an example of a spatial map management procedure according to an embodiment.

FIG. 4 may represent a procedure according to a create spatial map operation (or create spatial map service operation) (e.g., Create spatial map) among spatial map management operations. The procedure for the create spatial map operation (or create spatial map service operation) may allow the spatial map consumer 310 (e.g., the spatial map client 150 or the VAL server 210) to request the spatial map server 330 to create a spatial map of an area of interest. In response to the request of the spatial map consumer 310, the spatial map server 330 may create a spatial map. The spatial map may be structured in a plurality of layers. Each layer may signify a specific aspect (e.g., a 3D space of an area of interest, an object) of spatial information.

In operation 410, the spatial map consumer 310 may transmit a create spatial map request (e.g., Create spatial map request) to the spatial map server 330 to create a spatial map. The spatial map consumer 310 may transmit a request message corresponding to the create spatial map request to the spatial map server 330. The request (e.g., Create spatial map request) may include a requester ID, security credentials, a 3D area of interest, and information (e.g., access control rules defining which entities are permitted to discover and access the spatial map, etc.) to be included in the spatial map. The request (e.g., Create spatial map request) may include spatial map layering information parameters. Additionally, the request (e.g., Create spatial map request) may include augmented layer information that may be requested with the spatial map.

The spatial map server 330 may obtain augmented layer information and may provide the obtained augmented layer information to the spatial map consumer 310 in the response message.

Table 3 may describe information elements included in the create spatial map request (e.g., a create spatial map request message) transmitted from the spatial map consumer 310 to the spatial map server 330 for a create spatial map request.

TABLE 3

| Information element | Status | Description |
|---|---|---|
| Requestor identity | M | The identity of the requestor (e.g., VAL |
| | | server or SM client) |
| Requestor security | M | The security credentials of the |
| credentials | | requestor. |
| Application service ID | M | ID of the requesting VAL application |
| | | service |
| Area of interest | M | 3D area information to produce the |
| | | spatial map |
| Notification | O | Notification target address (e.g. URL, |
| Target Address | | URI, IP) where the notifications should |
| | | be sent. |
| Information to include | O | Information to be included in the |
| | | spatial map |
| > Access control rules | O | Access control rules defining which |
| | | entities are permitted to discover and |
| | | access the spatial map |
| > List of spatial | 0 | List of spatial map layer information. |
| map layers | | Each element includes the information |
| | | described below. |
| >> Spatial map layer | O | Information to specify the |
| information | | corresponding spatial map layer |
| | | specific information |
| > Augmented layer | O | List of required augmented layer |
| information | | information. This IE may contain |
| | | multiple values. Possible values are: |
| | | VAL_USERS; |
| | | SPATIAL_ANCHORS. |

In operation 413, the spatial map server 330 may request sensing data (or sensor data) from a UE (e.g., authorized UE(s)) and/or 3^{rd} party provider(s) in response to a request (e.g., Create spatial map request).

In operation 415, the UE (e.g., authorized UE(s)) and/or 3^{rd} party provider(s) may transmit sensing data (or sensor data) to the spatial map server 330. For example, the UE (e.g., authorized UE(s)) and/or 3^{rd} party provider(s) may obtain sensing data (or sensor data) and process the sensing data (or sensor data). The UE (e.g., authorized UE(s)) and/or 3^{rd} party provider(s) may transmit the processed sensing data (or processed sensor data) to the spatial map server 330.

In operation 420, the spatial map server 330 may authorize the spatial map consumer 310 and validate the request (e.g., Create spatial map request). The spatial map server 330 may produce a requested spatial map using layering information and the sensing data (or sensor data). For example, the sensing data (or sensor data) may be processed sensing data (or processed sensor data).

a) When the augmented layer information indicates to include VAL UE information, the spatial map server 330 may fetch a list of VAL UEs in the area of interest from an LM server (e.g., as specified in clause 9.3.10 of 3GPP TS 23.434) and/or from a NEF (e.g., as specified in 3GPP TS 23.502).

b) When the augmented layer information indicates to include spatial anchors information within an area of interest, the spatial map server 330 may fetch a list of spatial anchors in the area of interest.

The processed sensor data is stored in a VAL layer (e.g., in a database of the VAL layer), and the spatial map server 330 accesses the database to create a spatial map, which may be performed in an application specific way.

In operation 430, the spatial map server 330 may transmit a create spatial map response to the create spatial map request to the spatial map consumer 310. The spatial map server 330 may transmit a response message (e.g., a create spatial map response message) to the spatial map consumer 310 for the create spatial map request. The spatial map server 330 may transmit the response message to the spatial map consumer 310 with an indication of success, in-progress, or failure. The response message may include an indication. When the requested spatial map is created successfully, the response message may include an assigned spatial map ID and information. The information may include a 3D space defined by the spatial map. The response message may include a list of spatial map layers and their corresponding layer ID, objects belonging to the layers, etc. When the response indicates “in-progress”, an assigned spatial map ID may be included in the response message. Additionally, when the response indicates “in-progress” and the spatial map consumer 310 has not provided a notification target address, the spatial map consumer 310 may subscribe to spatial map events to receive notification when the spatial map is created. Otherwise, the response may include an indication of failure and may include a reason for the failure.

Table 4 may describe information elements included in a create spatial map response (e.g., a create spatial map response message) transmitted by the spatial map server 330 to the spatial map consumer 310.

TABLE 4

| Information | | |
|---|---|---|
| element | Status | Description |
| Application | O | ID of the requesting VAL application |
| service ID | | service |
| Success response | O (NOTE) | Information on the created spatial map. |
| | | It contains information as specified in |
| | | Table 1. |
| > Spatial map | M | The information about the created |
| information | | spatial map as described in Table 1. |
| > Augmented | O | Augmented layer information |
| layer information | | provided by SM server |
| Failure response | O (NOTE) | Indicates failed create spatial map |
| > Cause | O | Cause of the failure |

NOTE:
At least one of the information elements shall be provided.

In operation 440, when the spatial map consumer 310 provides a notification target address in the request (e.g., Create spatial map request) or subscribes to a spatial map event, the spatial map server 330 may notify the spatial map consumer 310 with a spatial map ready notification message. The notification (e.g., the spatial map ready notification message) may include parameters as specified in Table 15. When the response indicates “in-progress,” the spatial map server 330 may detect when the spatial map server 330 has sufficient information to map all objects related to the area of interest and the spatial map is ready to provide service (e.g., employed for localization).

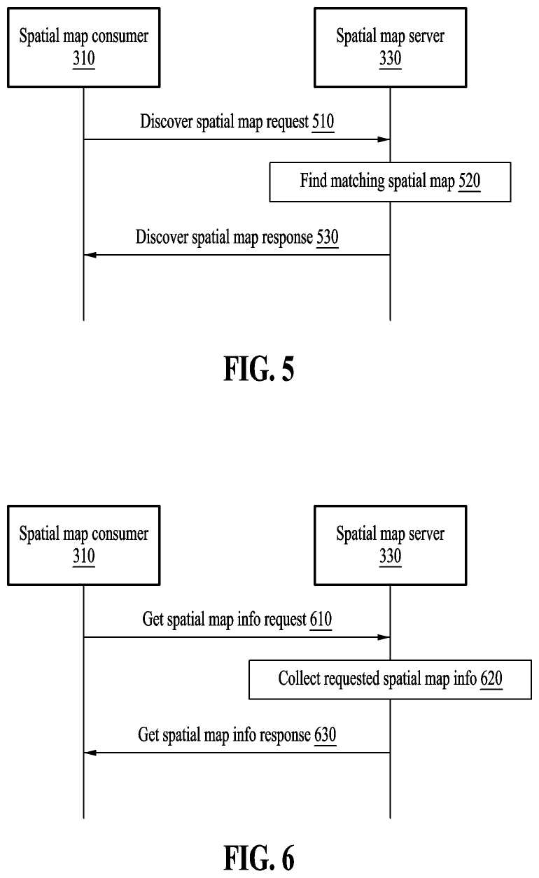

FIG. 5 is a diagram illustrating another example of a spatial map management procedure according to an embodiment.

FIG. 5 may represent a procedure according to a discover spatial map operation (or discover spatial map service operation) (e.g., Discover spatial map) among spatial map management operations. The procedure for the discover spatial map operation (or discover spatial map service operation) may allow the spatial map consumer 310 (e.g., the spatial map client 150 or the VAL server 210) to request the spatial map server 330 to discover spatial maps of an area of interest.

In operation 510, the spatial map consumer 310 may transmit a discover spatial map request (e.g., Discover spatial map request) to the spatial map server 330 to discover spatial map(s). The spatial map consumer 310 may transmit a request message (e.g., a discover spatial map request message) corresponding to the discover spatial map request to the spatial map server 330. The request (e.g., Discover spatial map request) may include a requestor ID, security credentials, a 3D area of interest, or localization information to discover a spatial map in the area. The request (e.g., Discover spatial map request) may include optional discovery filters i.e., a set of characteristics (e.g., a list of specific spatial map layers) to search for a matching spatial map when multiple spatial maps are allowed in the area of interest.

How the requestor identifies the 3D area of interest may be implementation-specific. Table 5 may describe information elements included in a discover spatial map request (e.g., a discover spatial map request message) transmitted by the spatial map consumer 310 to the spatial map server 330.

TABLE 5

| Information element | Status | Description |
|---|---|---|
| Requestor identity | M | The identity of the requestor (e.g., |
| | | VAL server or spatial map client) |
| Requestor security | M | The security credentials of the |
| credentials | | requestor. |
| Application service ID | M | ID of the requesting VAL |
| | | application service |
| Filtering criteria | M | Criteria to get spatial map(s) |
| > Area of interest | O | 3D area information to discover |
| | (NOTE) | spatial map |
| > Location information | O | Location, orientation and pose |
| | (NOTE) | information that is used to identify |
| | | relevant spatial maps. |
| > Optional discovery | O | A set of characteristics to search the |
| filters | | matching spatial maps |
| >> List of spatial map | O | The list of spatial map layers to |
| layers | | discover spatial map(s) with |
| | | matching layers. Each element |
| | | includes the information described |
| | | below. |
| >>> Spatial map layer | O | Information to specify the |
| information | | corresponding spatial map layer |
| | | specific information. |

NOTE:
At least one of the information elements shall be provided.

In operation 520, the spatial map server 330 may authorize the spatial map consumer 310 and validate the request (e.g., Discover spatial map request). The spatial map server 330 may then determine a spatial map based on the requested filtering criteria. For example, the spatial map server 330 may find spatial map(s) that match(es) the filtering criteria.

In operation 530, the spatial map server 330 may transmit a discover spatial map response to the spatial map consumer 310 for the discover spatial map request. The spatial map server 330 may transmit a response message (e.g., a discover spatial map response message) to the spatial map consumer 310 for the discover spatial map request. When the request (e.g., Discover spatial map request) is successful, the response (e.g., Discover spatial map response) may include determined spatial map information (e.g., spatial map information for a spatial map that matches the filtering criteria). When the request is not successful, the response may include an indication of failure. Additionally, the response may include a failure reason.

Table 6 may describe information elements included in a discover spatial map response (e.g., a discover spatial map response message) transmitted by the spatial map server 330 to the spatial map consumer 310.

TABLE 6

| Information element | Status | Description |
|---|---|---|
| Application service ID | O | ID of the requested VAL application |
| | | service |
| Success response | O | Indicates successful discovery |
| | (NOTE) | |
| > List of discovered | M | List of ID(s) of the discovered spatial |
| spatial maps | | map(s). Each element includes the |
| | | information described below |
| >> Spatial map ID | M | ID of a spatial map discovered |
| Failure response | O | Indicates failed discovery |
| | (NOTE) | |
| > Cause | O | Cause of the failure |

NOTE:
At least one of the information elements shall be provided.

FIG. 6 is a diagram illustrating another example of a spatial map management procedure according to an embodiment.

FIG. 6 may represent a procedure according to a get spatial map information operation (or get spatial map information service operation) (e.g., Get spatial map information) among spatial map management operations. The procedure for the get spatial map information operation (or get spatial map information service operation) may allow the spatial map consumer 310 (e.g., the spatial map client 150 or the VAL server 210) to request the spatial map server 330 to get information about a specific spatial map (e.g., all detailed information about a specific spatial map).

In operation 610, the spatial map consumer 310 may transmit a get spatial map information request (e.g., Get spatial map info request) to the spatial map server 330 to get spatial map information. The spatial map consumer 310 may transmit a request message (e.g., a get spatial map info request message) corresponding to the get spatial map information request to the spatial map server 330. The request (e.g., Get spatial map info request) may include a requestor ID, security credentials, and a spatial map ID.

Table 7 may describe information elements included in a get spatial map information request (e.g., a get spatial map info request message) transmitted by the spatial map consumer 310 to the spatial map server 330.

TABLE 7

| Information element | Status | Description |
|---|---|---|
| Requestor ID | M | The identity of the requestor (e.g., VAL |
| | | server or spatial map client) |
| Requestor security | M | The security credentials of the |
| credentials | | requestor. |
| Application service ID | M | ID of the requesting VAL application |
| | | service |
| Spatial map ID | M | ID of the spatial map to get information |
| | | on it |
| > List of spatial | O | A list of spatial map layers for which |
| map layers | | information is requested. |

In operation 620, the spatial map server 330 may authorize the spatial map consumer 310 and validate the request (e.g., Get spatial map info request). When the request is authorized, the spatial map server 330 may determine information about the requested spatial map (or spatial map information). For example, the spatial map server 330 may collect information about the requested spatial map.

In operation 630, the spatial map server 330 may transmit a get spatial map information response (e.g., Get spatial map info response) to the spatial map consumer 310 in response to the get spatial map information request (e.g., Get spatial map info request). The spatial map server 330 may transmit a response message (e.g., a get spatial map info response message) to the spatial map consumer 310. When the request (e.g., Get spatial map info request) is successful, the response (e.g., the get spatial map info response message) may include spatial map information. When the request is not successful, the response may include an indication of failure. Additionally, the response may include a failure reason.

Table 8 may describe information elements included in a get spatial map information response (e.g., a get spatial map info response message) transmitted by the spatial map server 330 to the spatial map consumer 310.

TABLE 8

| Information element | Status | Description |
|---|---|---|
| Spatial map ID | M | ID of the requested spatial map to get |
| | | information |
| Application service ID | O | ID of the requesting VAL application |
| | | service |
| Success response | O | Indicates successful get information |
| | (NOTE) | |
| > Spatial map | M | Information about the requested |
| information | | spatial map as specified in Table 1. |
| Failure response | O | Indicates failed get information |
| | (NOTE) | |
| > Cause | O | Cause of the failure |

NOTE:
At least one of the information elements shall be provided.

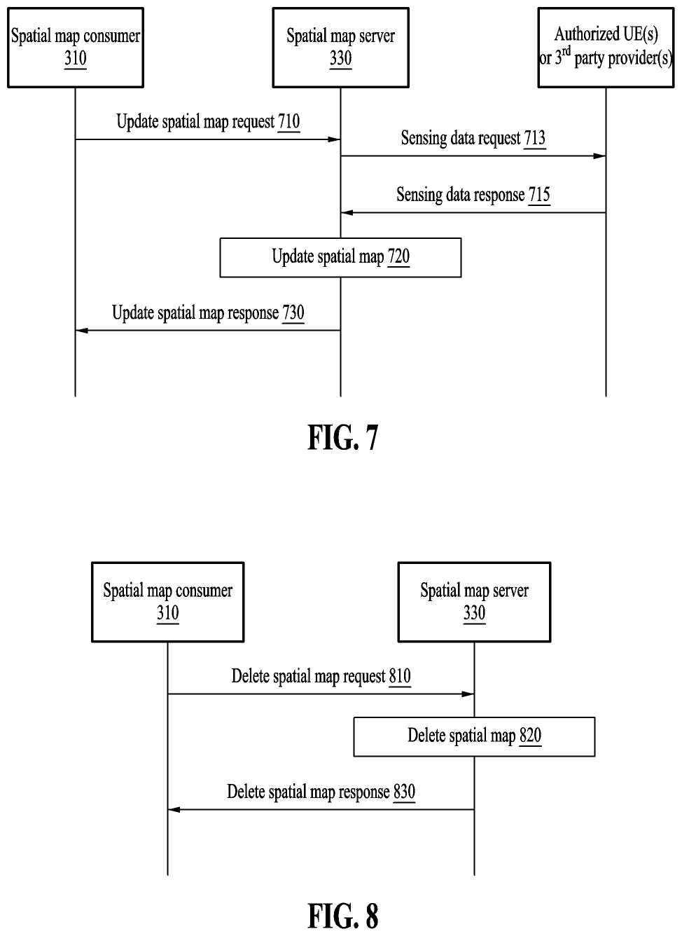

FIG. 7 is a diagram illustrating another example of a spatial map management procedure according to an embodiment.

FIG. 7 may represent a procedure according to an update spatial map operation (or update spatial map service operation) (e.g., Update spatial map) among spatial map management operations. The procedure for the update spatial map operation (or update spatial map service operation) may allow the spatial map consumer 310 (e.g., the spatial map client 150 or the VAL server 210) to request the spatial map server 330 to update a spatial map. In response to a request from the spatial map consumer 310, the spatial map server 330 may update the spatial map.

In operation 710, the spatial map consumer 310 may transmit an update spatial map request (e.g., Update spatial map request) to the spatial map server 330 to update a spatial map. The spatial map consumer 310 may transmit a request message (e.g., an update spatial map request message) corresponding to the update spatial map request to the spatial map server 330. The request (e.g., Update spatial map request) may include a requestor ID, security credentials, a spatial map ID, and information (e.g., updated spatial map layering information and updated spatial map coverage area) about the update. As part of the update, the request may include augmented layer information (e.g., VAL users, spatial anchors).

Table 9 may describe information elements included in an update spatial map request (e.g., an update spatial map request message) transmitted by the spatial map consumer 310 to the spatial map server 330.

TABLE 9

| Information element | Status | Description |
|---|---|---|
| Requestor ID | M | The identity of the requestor (e.g., |
| | | VAL server or SM client) |
| Requestor security | M | The security credentials of the |
| credentials | | requestor. |
| Application service ID | M | ID of the requesting VAL application |
| | | service |
| Spatial map ID | M | ID of the spatial map to update |
| Spatial map update | M | The spatial map information to update |
| information | | as described in described in Table 1. |
| | | Only IEs required to be updated are |
| | | included. |
| > Augmented layer | O | List of required augmented layer |
| information | | information. This IE may contain |
| | | multiple values. Possible values are: |
| | | VAL_UE; |
| | | SPATIAL_ANCHORS. |

In operation 713, the spatial map server 330 may request sensing data (or sensor data) from UEs (e.g., authorized UE(s)) and/or 3^{rd} party provider(s) in response to a request (e.g., an update spatial map request).

In operation 715, the UE (e.g., authorized UE(s)) and/or 3^{rd} party provider(s) may transmit sensing data (or sensor data) to the spatial map server 330. For example, the UE (e.g., authorized UE(s)) and/or 3^{rd} party provider(s) may obtain sensing data (or sensor data) and process the sensing data (or sensor data). The UE (e.g., authorized UE(s)) and/or 3^{rd} party provider(s) may transmit the processed sensing data (or processed sensor data) to the spatial map server 330.

In operation 720, the spatial map server 330 may authorize the spatial map consumer 310 and validate the request (e.g., Update spatial map request). The spatial map server 330 may update the spatial map according to the request. The spatial map server 330 may update the spatial map using sensing data (or sensor data). For example, the sensing data (or sensor data) may be processed sensing data (or processed sensor data).

In operation 730, the spatial map server 330 may transmit an update spatial map response (e.g., Update spatial map response) to the update spatial map request (e.g., Update spatial map request) to the spatial map consumer 310. The spatial map server 330 may transmit a response message (e.g., an update spatial map response message) to the update spatial map request to the requester. The response message may include updated spatial map information including a spatial map ID and a result of the request. The spatial map server 330 may include the requested augmented layer information in the response message.

Table 10 may describe information elements included in an update spatial map response (e.g., an update spatial map response message) transmitted by the spatial map server 330 to the spatial map consumer 310.

TABLE 10

| Information element | Status | Description |
|---|---|---|
| Spatial map ID | M | ID of the requested spatial map for |
| | | update information |
| Application | O | ID of the requesting VAL application |
| service ID | | service |
| Success response | O | Indicates successful update |
| | (NOTE) | |
| > Spatial map | M | Updated spatial map information.) It |
| information | | contains information as specified in |
| | | Table 1. |
| > Augmented layer | O | Augmented layer information |
| information | | |
| Failure response | O (NOTE) | Indicates failed update |
| > Cause | O | Cause of failure |

NOTE:
At least one of the information elements shall be provided.

FIG. 8 is a diagram illustrating another example of a spatial map management procedure according to an embodiment.

FIG. 8 may represent a procedure according to a delete spatial map operation (or delete spatial map service operation) (e.g., Delete spatial map) among spatial map management operations. The procedure for the delete spatial map operation (or delete spatial map service operation) may allow the spatial map consumer 310 (e.g., the spatial map client 150 or the VAL server 210) to request the spatial map server 330 to delete a spatial map. In response to the request of the spatial map consumer 310, the spatial map server 330 May 10 delete the spatial map.

In operation 810, the spatial map consumer 310 may transmit a delete spatial map request (e.g., Delete spatial map request) to the spatial map server 330 to delete a spatial map. The spatial map consumer 310 may transmit a request message (e.g., a delete spatial map request message) corresponding to the delete spatial map request to the spatial map server 330. The request (e.g., Delete spatial map request) may include a requestor ID, security credentials, and a spatial map ID.

Table 11 may describe information elements included in a delete spatial map request (e.g., Delete spatial map request message) transmitted by the spatial map consumer 310 to the spatial map server 330.

TABLE 11

| Information element | Status | Description |
|---|---|---|
| Requestor ID | M | The identity of the requestor (e.g., |
| | | VAL server or SM client) |
| Requestor security | M | The security credentials of the |
| credentials | | requestor. |
| Spatial map ID | M | Spatial map ID to delete |

In operation 820, the spatial map server 330 may authorize the spatial map consumer 310 and validate the request (e.g., Delete spatial map request). The spatial map server 330 may delete the spatial map according to the request.

In operation 830, the spatial map server 330 may transmit a delete spatial map response (e.g., Delete spatial map response) to the spatial map consumer 310 for the delete spatial map request (e.g., Delete spatial map request). The response message may include a success or failure result.

Table 12 may describe information elements included in a delete spatial map response (e.g., a delete spatial map response message) transmitted by the spatial map server 330 to the spatial map consumer 310.

TABLE 12

| Information element | Status | Description |
|---|---|---|
| Success response | O (NOTE) | Indicates successful delete |
| Failure response | O (NOTE) | Indicates failed delete |
| > Cause | O | Cause of failure |

NOTE:
At least one of the information elements shall be provided.

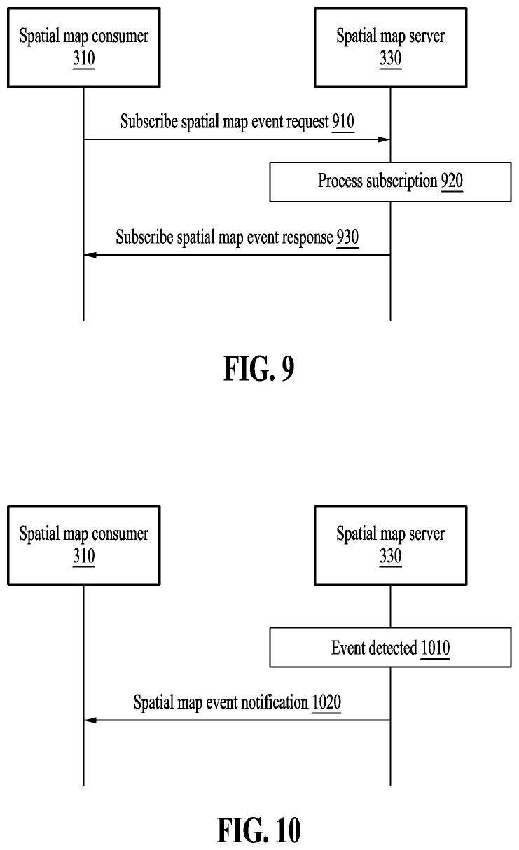

FIG. 9 is a diagram illustrating another example of a spatial map management procedure according to an embodiment.

FIG. 9 may represent a procedure according to a subscribe spatial map operation (or subscribe spatial map service operation) among spatial map management operations. FIG. 9 may represent a procedure for the spatial map consumer 310 (e.g., the spatial map client 150 or the VAL server 210) to subscribe to a spatial map event. When the spatial map server 330 detects a subscribed event, the spatial map consumer 310 may obtain notification information from the spatial map server 330.

In operation 910, the spatial map consumer 310 may transmit a subscribe spatial map event request (e.g., Subscribe spatial map event request), which is a request to subscribe to a spatial map event, to the spatial map server 330. The spatial map consumer 310 may transmit a request message (e.g., a subscribe spatial map event request message) corresponding to the subscribe spatial map event request to the spatial map server 330. The request (e.g., Subscribe spatial map event request) may include a requestor ID, security credentials, a notification endpoint, a spatial map ID(s), and event(s) to subscribe that trigger(s) a notification. The request may include a list of spatial map layers and corresponding layer IDs for subscribing to events related to spatial map layering information. The spatial map consumer 310 may subscribe to one or more of the following events:
a) “changes of objects” event to indicate the spatial map server 330 to notify the spatial map consumer 310 when changes of objects are detected. The notification triggering criteria for the “changes of objects” event may include added or removed objects, position or direction changes of the spatial map objects.
b) “layers modification” event to indicate the spatial map server 330 to notify the spatial map consumer 310 when any layer in the spatial map is added or updated or removed.
c) “spatial map ready” event to indicate the spatial map server 330 to notify the spatial map consumer 310 when the spatial map server 330 has sufficient information to map all the objects related to an area of interest, and the spatial map is ready to provide service (e.g. employed for localization). This event may be used when the result IE in the Create spatial map response indicates “in-progress”.

Table 13 may describe information elements included in a subscribe spatial map event request (e.g., Subscribe spatial map event request message) transmitted by the spatial map consumer 310 to the spatial map server 330.

TABLE 13

| Information element | Status | Description |
|---|---|---|
| Requestor identity | M | The identity of the requestor (e.g., |
| | | VAL server or VAL user) |
| Security credentials | M | The security credentials of the |
| | | requestor. |
| Application | M | ID of the requesting VAL application |
| service ID | | service |
| Expiry time | O | Proposed subscription expiry time |
| Target spatial map(s) | M | Spatial map(s) to subscribe |
| > List of spatial | O | ID(s) of the spatial map(s) to |
| map IDs | | subscribe |
| > Area of interest | O | 3D area information to discover |
| | | spatial map(s) to subscribe |
| List of events | M | Events to subscribe. Each element |
| | | includes the information described |
| | | below. |
| > Event type | O | List of events to subscribe. Possible |
| | | values are: |
| | | Change of objects |
| | | Layers modification |
| | | Spatial map ready |
| > Specified objects | O | List of specified objects for |
| | | “change of objects” event |
| > Triggering criteria | O | Specifies the condition to determine |
| | | whether the event has occurred, e.g. |
| | | Spatial map is employed and ready |
| | | for localization service. |
| >> Changes | O (NOTE) | Triggers notification when any or |
| in objects | | specified (or specified type of) |
| | | objects are added, removed, etc. |
| >> Layer IDs | O (NOTE) | List of layers. Triggers notification |
| | | when any or specified spatial map |
| | | layer change is detected. |
| > Notification | | Specifies when to notify the detected |
| intervals | | event. |
| | | Possible values are: |
| | | Event based (e.g., promptly); or |
| | | Periodically (with minimum time |
| | | between consecutive notifications) |
| | | Intervals (i.e. minimum time |
| | | between consecutive notifications) |
| > Interval time | O | Time between consecutive |
| | | notifications (applicable only if |
| | | notification intervals is set to |
| | | intervals.) |

NOTE:
At least one of the sub-elements shall be provided.

In operation 920, the spatial map server 330 may authorize the spatial map consumer 310 and validate the request (e.g., Subscribe spatial map event request). The spatial map server 330 may then add the spatial map consumer 310 to the list of subscribers for the event. The spatial map server 330 may then start monitoring the event.

In operation 930, the spatial map server 330 may transmit a subscribe spatial map event response (e.g., Subscribe spatial map event response) to the spatial map consumer 310 for the subscribe spatial map event request (e.g., Subscribe spatial map event request). The spatial map server 330 may transmit a response message (e.g., a subscribe spatial map event response message) to the spatial map consumer 310 for the subscribe spatial map event request. The response message may include a result of the subscribe spatial map event request. When the subscribe spatial map event request is successful, the response message may include a subscription ID. When the subscribe spatial map event request is not successful, the response message may include an indication of failure. Additionally, the response message may include a reason for failure.

Table 14 may describe information elements included in a subscribe spatial map event response (e.g., a subscribe spatial map event response message) transmitted by the spatial map server 330 to the spatial map consumer 310.

TABLE 14

| Information element | Status | Description |
|---|---|---|
| Result | M | Result of the subscribe spatial map |
| | | event request |
| Subscription ID(NOTE) | O | Identity of the subscription |
| Expire time | O | Subscription expire time |
| Failure cause | O | Indicates reason for the failure. |

NOTE:
This IE (e.g., subscription ID) is mandatory when Result IE indicates success.

FIG. 10 is a diagram illustrating another example of a spatial map management procedure according to an embodiment.

FIG. 10 may represent a procedure according to a subscribe spatial map operation (or subscribe spatial map service operation) among spatial map management operations. FIG. 10 may represent a procedure in which the spatial map server 330 transmits a spatial map event notification (e.g., Notify spatial map event) to the spatial map consumer 310 (e.g., the spatial map client 150 or the VAL server 210) that subscribes to a spatial map event.

In operation 1010, the spatial map server 330 may detect an event that triggers a notification to a subscriber (e.g., the spatial map consumer 310) for the corresponding event.
a) When the subscribed event is “changes of objects”, the spatial map server 330 may detect any changes of the spatial map objects.
b) When the subscribed event is “layers modification”, the spatial map server 330 may detect any changes of the spatial map layer information.
c) When the subscribed event is “spatial map ready”, the spatial map server 330 may detect when the spatial map server 330 has sufficient information to map all the objects related to an area of interest and the spatial map is ready to provide service (e.g. employed for localization).

The spatial map server 330 may determine whether the detected event matches triggering criteria and may notify the subscriber (e.g., the spatial map consumer 310) accordingly.

In operation 1020, the spatial map server 330 may transmit a notification (e.g., a Spatial map event notification) to the spatial map consumer 310 that has subscribed to the event. The spatial map server 330 may transmit a spatial map event notification message corresponding to the notification to the spatial map consumer 310. The notification (e.g., the spatial map event notification message) may include a subscription ID and event-specific information. When the event is “changes of objects”, the spatial map event notification message may include information about the detected triggering event (e.g., added or removed objects, position or direction changes of the objects in the spatial map, etc.). When the event is “layer modification”, the spatial map event notification message may include a list of all layers of the spatial map.

Table 15 may describe information elements included in a spatial map event notification (e.g., a spatial map event notification message) transmitted by the spatial map server 330 to the spatial map consumer 310.

TABLE 15

| Information element | Status | Description |
|---|---|---|
| Subscription ID | M | Subscription ID for the event |
| Notification | M | Specifies what matches the triggering |
| information | | notification condition, including |
| | | related information |
| > Spatial map ID | M | ID of the spatial map for which the |
| | | event is detected |
| > Event type | M | Type of event detected. One of the |
| | | events as specified in Table 13. |
| >> Changed object | O (NOTE1) | Information on the object which |
| | | triggered the notification |
| >>> Object ID | O | ID of the changed object |
| >>> Type of change | O | Specifies the detected type of change |
| | | for the object (e.g., added, removed, |
| | | or changed position or direction) |
| >>> Changed object | O | A container to carry the changed |
| information | | object specific information |
| >> List of layers | C | Information about layers for the |
| (NOTE 2) | | spatial map. |

NOTE 1:
This IE is applicable for “changes of objects” event type.
NOTE 2:
This IE is applicable for “layer modification” event type.

FIG. 11 is a diagram illustrating another example of a spatial map management procedure according to an embodiment.

FIG. 11 may represent a procedure according to a subscribe spatial map operation (or subscribe spatial map service operation) among spatial map management operations. FIG. 11 may represent a procedure for the spatial map consumer 310 (e.g., the spatial map client 150 or the VAL server 210) to unsubscribe from a spatial map event.

In operation 1110, the spatial map consumer 310 may transmit an unsubscribe spatial map event request (e.g., Unsubscribe spatial map event request) to the spatial map server 330 to cancel a spatial map event subscription. The spatial map consumer 310 may transmit a request message (e.g., an unsubscribe spatial map event request message) corresponding to the unsubscribe spatial map event request to the spatial map server 330. The request (e.g., Unsubscribe spatial map event request) may include a requester ID, security credentials, and an event subscription ID.

Table 16 may describe information elements included in an unsubscribe spatial map event request (e.g., an unsubscribe spatial map event request message) transmitted by the spatial map consumer 310 to the spatial map server 330.

TABLE 16

| Information element | Status | Description |
|---|---|---|
| Requestor ID | M | The identity of the requestor (e.g., |
| | | VAL server or VAL user) |
| Security credentials | M | The security credentials of the |
| | | requestor. |
| Subscription ID | M | Subscription ID for the event |

In operation 1120, the spatial map server 330 may authorize the spatial map consumer 310 and validate the request (e.g., Unsubscribe spatial map event request). The spatial map server 330 may then remove the subscription ID of the spatial map consumer 310 from the subscriber list for the spatial map event.

In operation 1130, the spatial map server 330 may transmit an unsubscribe spatial map event response (e.g., Unsubscribe spatial map event response) to the spatial map consumer 310 for the unsubscribe spatial map event request (e.g., Unsubscribe spatial map event request). The spatial map server 330 may transmit a response message (e.g., Unsubscribe spatial map event response) to the spatial map consumer 310 for the unsubscribe spatial map event request. The response message may include a result of the unsubscribe spatial map event request. When the unsubscribe spatial map event request is successful, the response message may include an indication of success. When the unsubscribe spatial map event request is not successful, the response message may include an indication of failure. Additionally, the response message may include a reason for failure.

Table 17 may describe information elements included in an unsubscribe spatial map event response (e.g., an unsubscribe spatial map event response message) transmitted by the spatial map server 330 to the spatial map consumer 310.

TABLE 17

| Information element | Status | Description |
|---|---|---|
| Result | M | Result of the subscribe spatial map |
| | | event request |
| Failure cause | O | Indicates reason for the failure. |

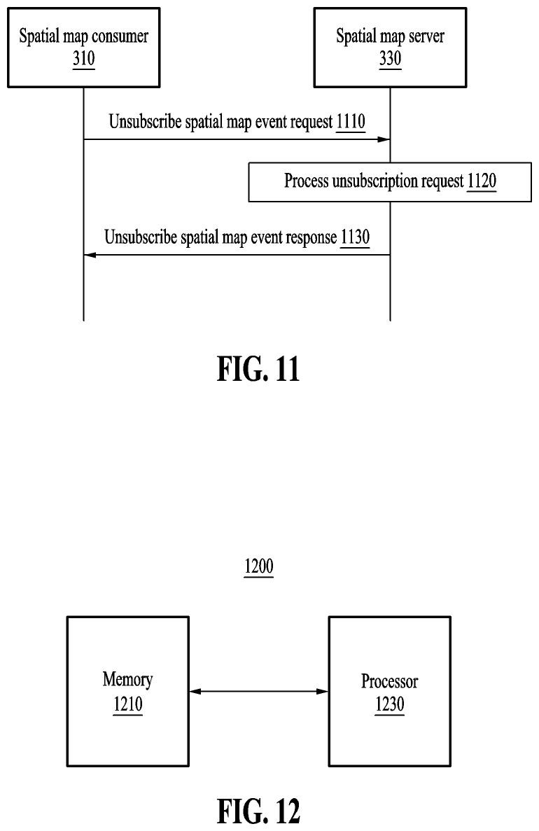

FIG. 12 is a schematic block diagram of a device supporting spatial map management according to an embodiment.

Referring to FIG. 12, according to an embodiment, a device 1200 (e.g., a terminal device or a server device) supporting spatial map management may be substantially identical to the spatial map consumer 310 or the spatial map server 330 described with reference to FIGS. 1 to 11. The device 1200 may include a memory 1210 and a processor 1230.

The memory 1210 may store instructions (e.g., programs) executable by the processor 1230. For example, the instructions may include instructions for executing operations of the processor 1230 and/or operations of each component of the processor 1230.

The memory 1210 may be implemented as a volatile memory device or a nonvolatile memory device. The volatile memory device may be implemented as a dynamic random access memory (DRAM), a static random access memory (SRAM), a thyristor RAM (T-RAM), a zero capacitor RAM (Z-RAM), or a twin transistor RAM (TTRAM). The nonvolatile memory device may be implemented as an electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, molecular electronic memory device, and/or insulator resistance change memory.

The processor 1230 may execute computer-readable code (e.g., software) stored in the memory 510 and instructions generated by the processor 530. The processor 530 may be a hardware-implemented data processing device having a circuit having a physical structure for executing desired operations. The desired operations may include, for example, code or instructions included in a program. The hardware-implemented data processing device may include, for example, a microprocessor, a central processing unit, a processor core, a multi-core processor, a multiprocessor, an application-specific integrated circuit (ASIC), and a field programmable gate array (FPGA).

The operation performed by the processor 1230 is substantially identical to the operation of the spatial map consumer 310 or the spatial map server 330 described with reference to FIGS. 1 to 11. Therefore, a detailed description is omitted.

The embodiments described herein may be implemented using hardware components, software components, or a combination thereof. A processing device may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and/or data may be embodied in any type of machine, component, physical or virtual equipment, computer storage medium or device capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), RAM, flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, other implementations, other embodiments, and equivalents to the claims are also within the scope of the following claims.

1. A method of managing information of a spatial map, comprising:
receiving a request for a service operation for spatial map management;
performing the service operation for the spatial map management; and
transmitting a response comprising a result of performing the service operation for the spatial map management to an entity requesting the service operation for the spatial map management,
wherein the service operation for the spatial map management comprises,
a create spatial map service operation, a get spatial map service operation, an update spatial map service operation, a delete spatial map service operation, and a subscribe spatial map service operation, and
wherein the information of the spatial map comprises a spatial map ID, spatial map coverage, access control rules, a list of spatial map layers, and objects of a spatial map.

2. The method of claim 1, wherein the access control rules define an entity capable of discovering and accessing the spatial map.

3. The method of claim 1, wherein the entity requesting the service operation for the spatial map management is a spatial map client or a VAL server.

4. The method of claim 1, further comprising:
transmitting a notification to an entity requesting a subscribe spatial map service operation among the service operation for the spatial map management in response to detecting an event for the spatial map.

5. The method of claim 4, wherein
when the event is a change of an object in the spatial map,
the notification comprises information about an addition, removal, change of location, or change of orientation of the object.

6. A device for managing information of a spatial map, comprising:
at least one processor including processing circuitry; and
memory storing instructions that, when executed by the at least one processor individually or collectively, cause the electronic device to,
receive a request for a service operation for spatial map management,
perform the service operation for the spatial map management, and
transmit a response comprising a result of performing the service operation for the spatial map management to an entity requesting the service operation for the spatial map management,
wherein the service operation for the spatial map management comprises,
a create spatial map service operation, a get spatial map service operation, an update spatial map service operation, a delete spatial map service operation, and a subscribe spatial map service operation, and
wherein the information of the spatial map comprises,
a spatial map ID, spatial map coverage, access control rules, a list of spatial map layers, and objects of a spatial map.

7. The device of claim 6, wherein
the access control rules define an entity capable of discovering and accessing the spatial map.

8. The device of claim 6, wherein
the entity requesting the service operation for the spatial map management is a spatial map client or a VAL server.

9. The device of claim 6, wherein
the instructions, when executed by the at least one processor individually or collectively, cause the electronic device to,
transmit a notification to an entity requesting a subscribe spatial map service operation among the service operation for the spatial map management in response to detecting an event for the spatial map.

10. The device of claim 9, wherein
when the event is a change of an object in the spatial map,
the notification comprises information about an addition, removal, change of location, or change of orientation of the object.

11. A non-transitory computer-readable storage medium storing instructions that, when executed by a processor, cause the processor to perform the method of claim 1.
